(19) United States
(12) Patent Application Publication
(10) Pub. No.: US 2011/0099821 A1
(43) Pub. Date: May 5, 2011

(54) IMAGE CALIBRATION DEVICE INTEGRATED WITH OPTICAL LOCATER

(75) Inventors: Jia-Jyun Hong, Guishan Shiang (TW); Ming-Chang Wu, Guishan Shiang (TW); Hung-Sheng Tien, Guishan Shiang (TW); Chi-Bin Wu, Guishan Shiang (TW)

(73) Assignee: AccuMIS Inc., Zhonghe City (TW)

(21) Appl. No.: 12/706,766

(22) Filed: Feb. 17, 2010

(30) Foreign Application Priority Data
Nov. 4, 2009 (TW) 098137338

(51) Int. Cl. G01D 21/00

(52) U.S. Cl. 33/227

(57) ABSTRACT

The present invention discloses an image calibration device integrated with an optical locater. The image calibration device includes an image calibrator and the optical locater. The image calibrator can be arranged on an image capturing device to act as a reference to calibrate the image taken by the image capturing device. The optical locater has at least one pointing light source, which is located on a surface of the image calibrator, so that the pointing light source is used to assist in marking the location aimed by the image calibrator, thereby realizing the area captured by the image capturing device.

### BACKGROUND OF THE INVENTION

1. Technical Field

The present invention relates to image calibration devices integrated with optical locater and, more particularly, to an image calibration device integrated with optical locater, wherein the image calibration device is applicable to a surgical navigation system.

2. Description of Related Art

Taking medical images as preparation for surgical operations is a commonly performed pre-surgical procedure for precisely locating the nidi to be treated. In recent years, the computer-aided locating technology has been increasingly applied in surgical operations for enhancing the locating accuracy. Among others, surgical navigation systems are the most popular means.

A surgical navigation system is a system that guides the surgeon to conduct a surgical operation according to the spacial information between surgical instruments and a nidus to be treated. Prior to the surgical operation, the surgeon may use a medical imaging approach to obtain images of the nidus, and electronically reconstruct the images to form a full view of the nidus. The full view can then be defined in a coordinate system and the relevant coordinates can be input to computers for preoperative route planning of surgical instruments, thereby ensuring the locating accuracy in the surgical operation.

FIG. 1 depicts a conventional C-arm image capturing device 10. FIG. 2A shows a conventional image calibration device 20. FIG. 2B illustrates the conventional C-arm image capturing device 10 taking an image correctly, and FIG. 2C illustrates the same device incorrectly taking an image.

Referring to FIG. 1, an image capturing device like the one depicted is typically used in a surgical navigation system for taking X-ray images of a patient's nidus. The C-arm image capturing device 10 has an X-ray emitting end 11 for emitting X-rays to photograph the patient's nidus, and an X-ray receiving end 12 for receiving the resultant X-ray images. In order to determine the coordinates of the nidus' location, the image calibration device 20 is provided at the front of the X-ray receiving end 12 of the C-arm image capturing device 10. As shown in FIG. 2A, the image calibration device 20 may be a positioning plate 22 with steel balls 21 as marker so that the images received at the X-ray receiving end 12 are images containing markings bearing the steel balls 21 (as shown in FIG. 2B). At this time, the relative coordinates of the steel balls 21, obtained from predeterminate data, can be used to confirm the coordinates corresponding to the nidus.

However, due to X-rays being comprised of invisible light, before obtaining the images, an operator essentially has no way of knowing whether the C-arm image capturing device 10 is properly aligned with the nidus or not. Furthermore, the coordinates corresponding to the nidus cannot be determined unless the area photographed by the C-arm image capturing device 10 fully covers the entire nidus. Consequently, if the C-arm image capturing device 10 fails to cover the entire nidus when capturing the image, the resultant image will be one as typified in FIG. 2C and rendered useless in determining the coordinates of the nidus. Additional image capturing procedures will be needed until a competent image can be obtained. Additionally, with the increase of time and incidence of image capturing, the amount of X-ray radiation received by the patient also increases substantially, becoming a significant concern to the patient's health.

In view of the above plight of the art, there is a need for improved image locating techniques.

### SUMMARY OF THE INVENTION

The present invention provides an image calibration device integrated with an optical locater, wherein the image calibrator, by utilizing the optical locater to target a location designated by the image calibrator, helps to minimize incidence in photography before a competent image is obtained.

The present invention provides an image calibration device integrated with an optical locater, wherein the image calibrator, by utilizing the optical locater to locate an imaging zone of the image capturing device, helps to improve imaging accuracy.

The present invention provides an image calibration device integrated with an optical locater, wherein the image calibration device serves to clearly show a location and a range of image capturing, so that the image capturing device can be easily directed at the target object to be photographed and produce clear images, thereby enhancing the locating accuracy.

To achieve the above effects, the image calibration device of the present invention includes an image calibrator and an optical locater, wherein the optical locater has at least one pointing light source, and is located on a surface of the image calibrator.

In the image calibration device integrated with the optical locater, the surface is further provided with a slideway, and the pointing light source is slidably coupled with the slideway.

In the image calibration device integrated with the optical locater, the pointing light source is a laser light source.

In the image calibration device integrated with the optical locater, the optical locater has two pointing light sources that are located at two opposite sides of the surface and aligned with each other.

In the image calibration device integrated with the optical locater, the optical locater has three pointing light sources that are arranged as three points of an imaginary triangle on the surface.

By implementing the present invention, at least the following progressive effects can be achieved:

1. The image calibrator, by utilizing the optical locater to target a location designated by the image calibrator, helps to improve the imaging accuracy and minimize incidence in photography before a competent image is obtained.

2. Due to its ability of clearly locating the nidus, the image calibrator helps to minimize incidence in photography before a competent image is obtained and thereby prevent the patient from receiving excessive X-ray radiation.

3. The image calibration device serves to clearly show the location and the range of image capturing, so as to enhance the locating accuracy.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 illustrates a conventional C-arm image capturing device;

FIG. 2A illustrate a conventional image calibration device;

FIG. 2B illustrates the conventional C-arm image capturing device taking an image properly;

FIG. 2C illustrates the conventional C-arm image capturing device taking an image improperly;

FIG. 3A is a schematic drawing showing an image calibration device integrated with an optical locater in use according to a first embodiment of the present invention;

FIG. 3B is a partially enlarged view of FIG. 3A of the part A;

FIG. 4A is a first applied aspect of the image calibration device integrated with the optical locater of the present invention;

FIG. 4B is a second applied aspect of the image calibration device integrated with the optical locater of the present invention;

FIG. 5A is a third applied aspect of the image calibration device integrated with the optical locater of the present invention;

FIG. 5B shows a slideway of FIG. 5A combined with a pointing light source; and

FIG. 6 is a schematic drawing showing the image calibration device integrated with an optical locater in use according to a second embodiment of the present invention.

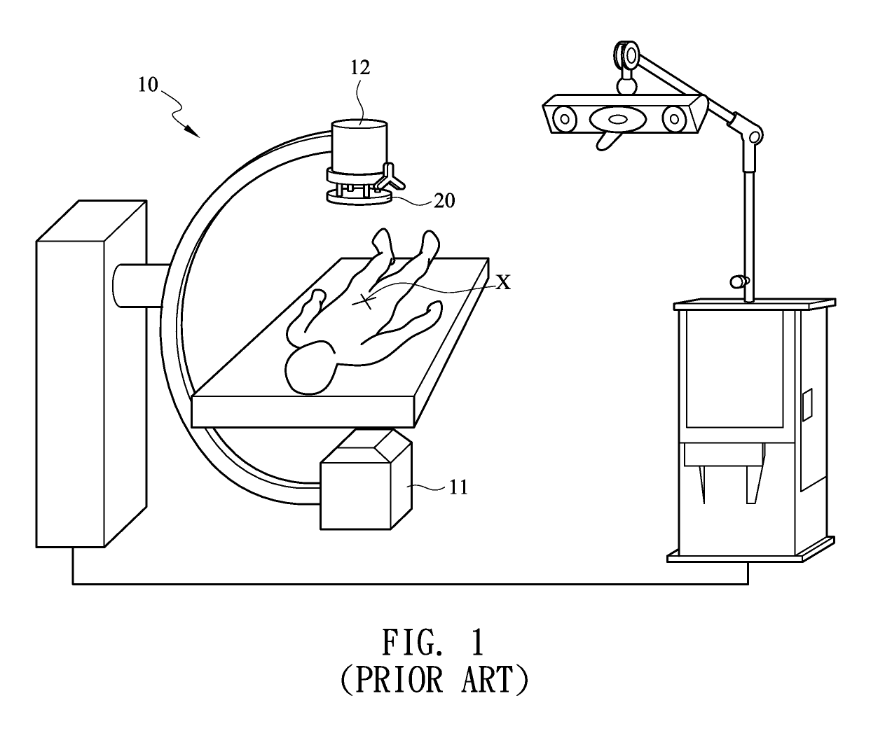

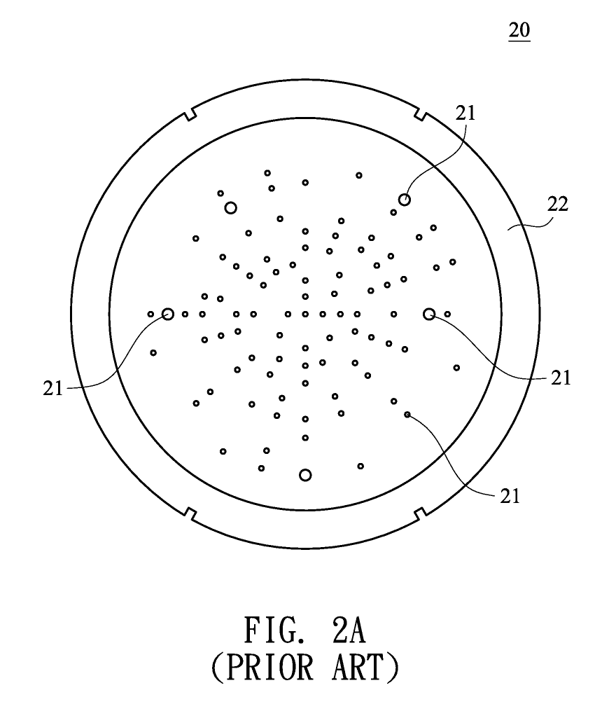

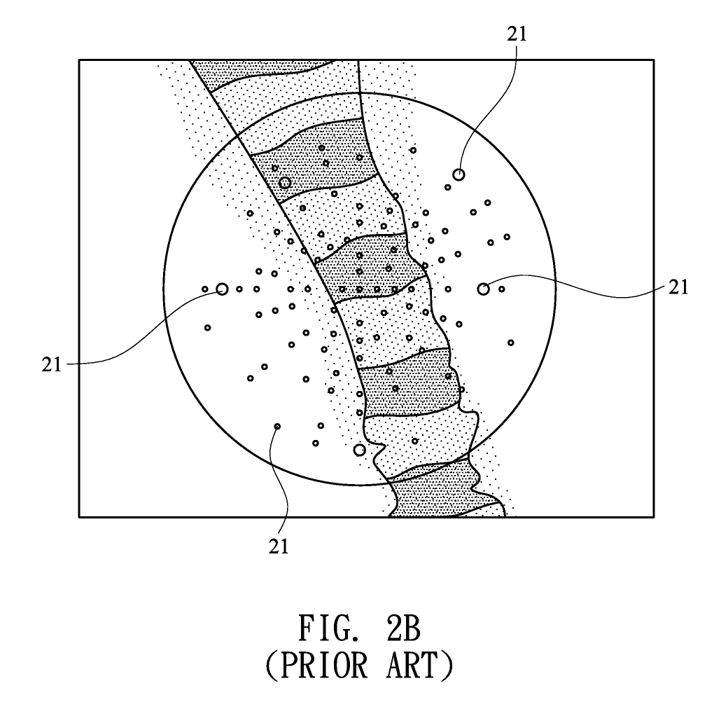

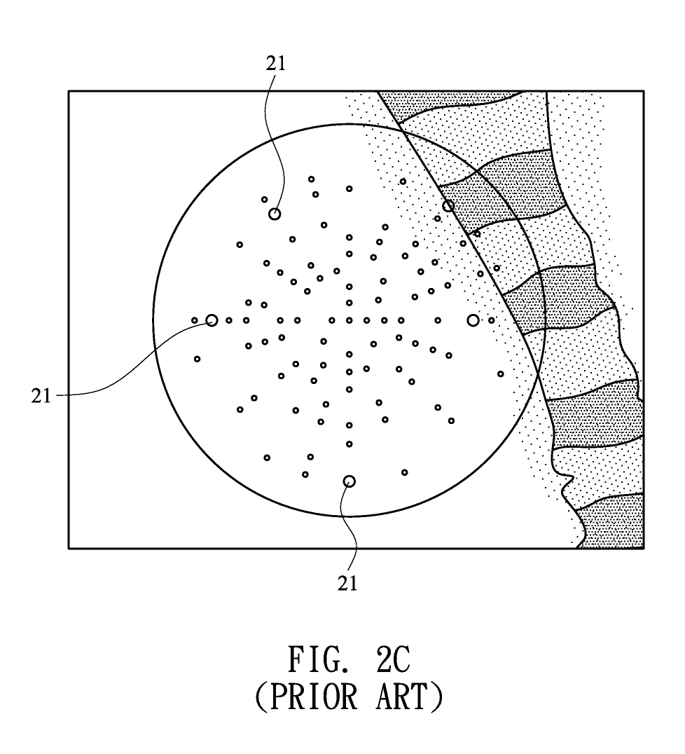

### DETAILED DESCRIPTION OF THE PREFERRED EMBODIMENTS

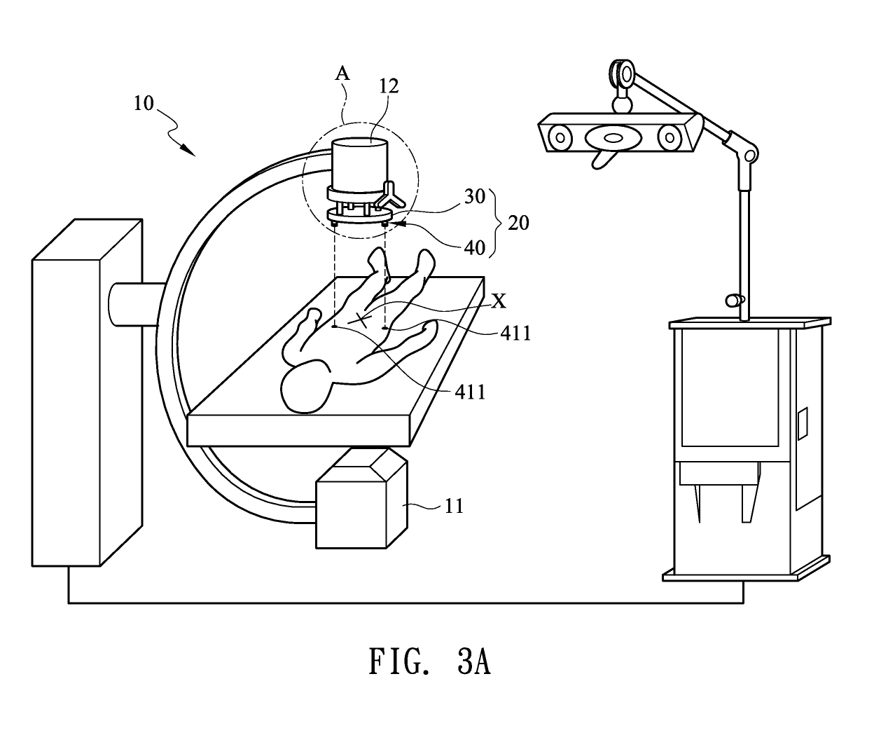

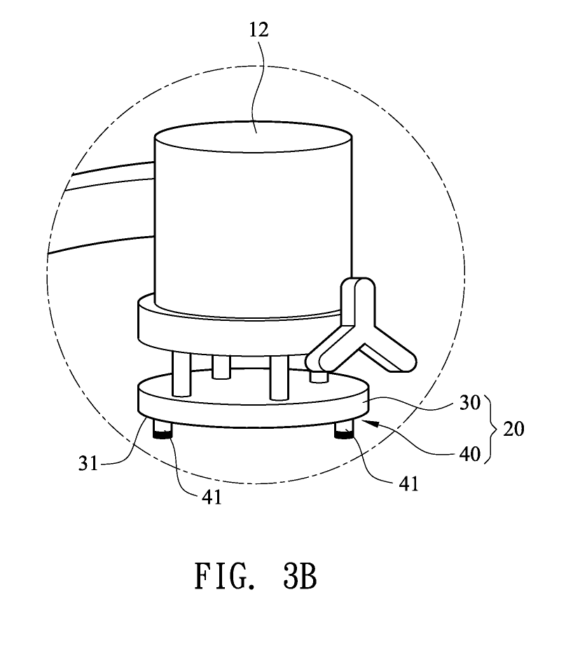

As shown in FIG. 3A, this embodiment is directed to an image calibration device 20, which has an image calibrator 30 and an optical locater 40.

The image calibrator 30 is deposited before an X-ray receiving end 12 of a C-arm image capturing device 10. Since in image capturing, a patient's nidus X is arranged between an X-ray emitting end 11 of the C-arm image capturing device 10 and the X-ray receiving end 12, a location aimed by the image calibrator 30 is the area photographed by the C-arm image capturing device 10.

As shown in FIG. 3A and FIG. 3B, the optical locater 40 is located on a surface 31 of the image calibrator 30, or in other words, located on the surface 31 of the image calibrator 30 facing the nidus X. The optical locater 40 has at least one pointing light source 41, such as a laser light source, so that the pointing light source 41 can be used to mark the location aimed by the image calibrator 30, thereby marking the area captured by the C-arm image capturing device 10.

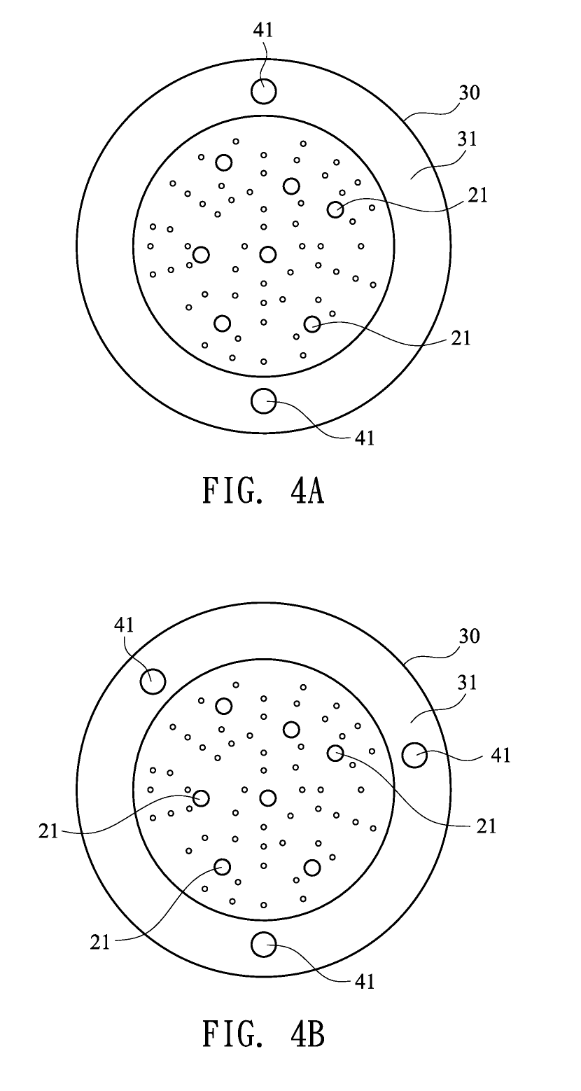

As shown in FIG. 3B, the optical locater 40 may alternatively have two said pointing light source 41, that are located at two opposite sides of the image calibrator 30 and aligned with each other. When the image calibrator 30 is a round plate, the two pointing light sources 41 may be settled at two opposite ends of a diameter of the round plate (as shown in FIG. 4A). Thereby, light beans emitted by the pointing light sources 41 can form two positioning light spots 411 on the patient's body (as shown in FIG. 3A) for defining the zone aimed by the image calibrator 30. Preferably, the nidus X is right located on an imaginary line connecting the two positioning light spots 411.

As shown in FIG. 4B, the optical locater 40 may alternatively have said three pointing light sources 41 that are arranged as three points of an imaginary triangle on the surface 31 of the image calibrator 30 so that the light beams emitted by the pointing light sources 41 can form three positioning light spots 411 on the patient's body (not shown), for facilitating an operator to confirm the location aimed by the image calibrator 30 and the area photographed by the C-arm image capturing device 10.

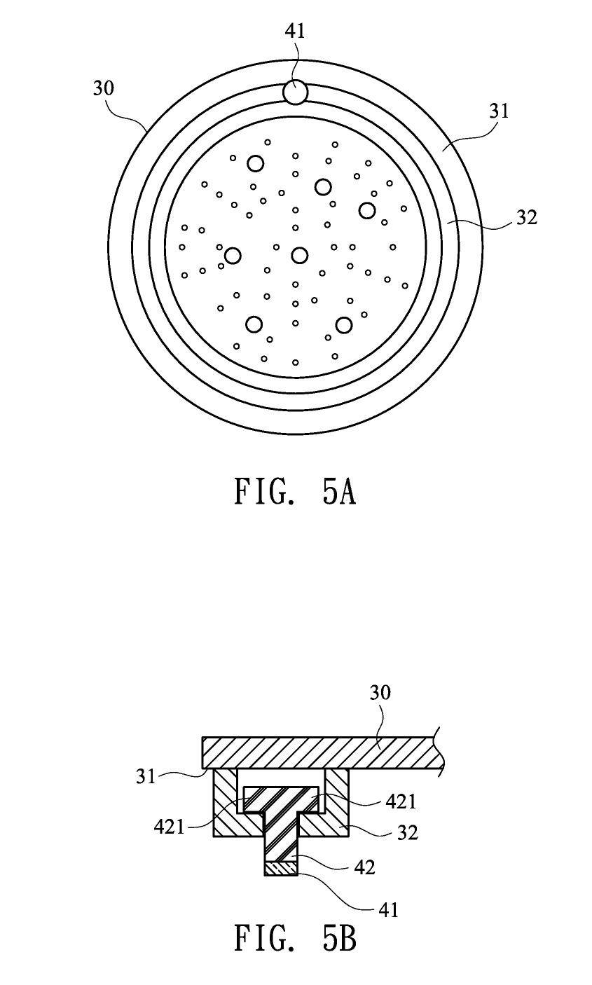

As shown in FIG. 5A, the surface 31 of the image calibrator 30 may be further provided with a slideway 32 extending along a periphery of the surface 31 of the image calibrator 30 as a circular slideway. Meantime, as shown in FIG. 5B, the pointing light source 41 may have a fastening seat 42 at a bottom thereof. The fastening seat 42 is configured with a pair of flanges 421 to be fittingly received in the slideway 32 so as to make the pointing light source 41 slidably coupled with the slideway 32.

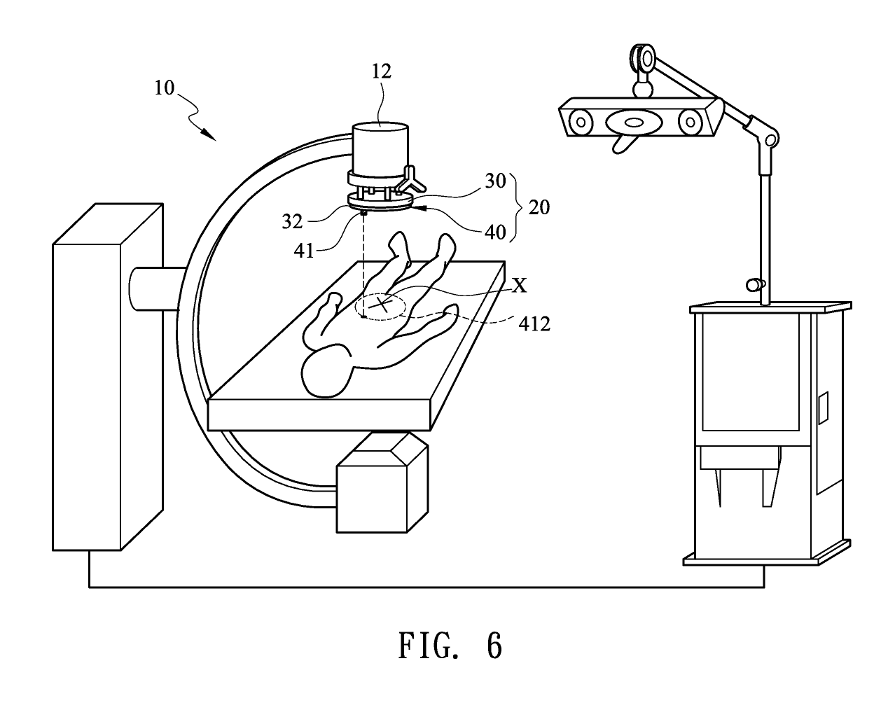

Therefore, as shown in FIG. 6, the optical locater 40 may merely have a single said pointing light source 41 that slides along the slideway 32 to project an optical track 412 on the patient's body, so as to assist the operator in confirming whether the nidus X is properly covered within the imaging zone of the image calibrator 30.

By providing the image calibrator 30 with the optical locater 40 that implements the pointing light source 41 to emit visible light beams, the present invention can direct the pointing light source 41 to locate the imaging zone target by the image calibrator 30, so as to improve imaging accuracy, thereby minimizing incidence of image capturing before a competent image is obtained, and in turn prevent the patient from receiving excessive X-ray radiation.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. An image calibration device integrated with an optical locater, the image calibration device comprising:
an image calibrator; and
the optical locater having at least one pointing light source and located on a surface of the image calibrator.

2. The image calibration device of claim 1, wherein the surface is further provided with a slideway, and the pointing light source is slidably coupled with the slideway.

3. The image calibration device of claim 1, wherein the pointing light source is a laser light source.

4. The image calibration device of claim 1, wherein the optical locater has two said pointing light sources, and the two pointing light sources are located at two opposite sides of the surface.

5. The image calibration device of claim 1, wherein the optical locater has three said pointing light sources that are arranged as three points of an imaginary triangle on the surface.
